(19) United States
(12) Patent Application Publication
(10) Pub. No.: US 2007/0064791 A1
(43) Pub. Date: Mar. 22, 2007

(54) Coding method producing generating smaller amount of codes for motion vectors

(76) Inventors: Shigeyuki Okada, Ogaki-shi (JP); Yuh Matsuda, Gifu-shi (JP); Hideki Yamauchi, Ogaki-shi (JP)

Correspondence Address: MCDERMOTT WILL & EMERY LLP, 600 13TH STREET, N.W., WASHINGTON, DC, 20005-3096, US

(21) Appl. No.: 11/520,024

(22) Filed: Sep. 13, 2006

(30) Foreign Application Priority Data
Sep. 13, 2005 (JP) 2005-265886

(51) Int. Cl. H04B 1/66; H04N 11/02

(52) U.S. Cl. 375/240.1; 375/240.16

(57) ABSTRACT

A motion vector coder performs coding on motion vectors MV₀, MV₁ and MV₂ in the stated order. Initially, the motion vector coder receives the motion vectors MV₀-MV₂ from a motion vector holder. The motion vector coder codes the motion vector MV₀ at the lowest layer 0. Subsequently, the motion vector coder codes (½*MV₀-MV₁), which is a difference between ½ of MV₀ and MV₁, instead of coding the motion vector MV₁ at layer 1. The motion vector coder then codes (½*MV₁-MV₂), which is a difference between ½ of MV₁ and MV₂, instead of coding the motion vector MV₂ at layer 2.

### BACKGROUND OF THE INVENTION

1. Field of the Invention

The present invention relates to a coding method for coding moving pictures.

2. Description of the Related Art

With the rapid development of broadband networks, services using high-quality moving pictures have drawn interest. Likewise, as the use of large-capacity recording mediums such as DVDs becomes popular, an increasing number of users enjoy high-quality images. Compression coding is known as an indispensable technology to transmit moving pictures by wire or store them in a recording medium. International standards for compression coding of motion pictures include MPEG 4 and H.264/AVC. There is also available a next-generation image compression technology such as scalable video coding (SVC) capable of producing both a high-quality stream and a low-quality stream.

In streaming high-resolution moving pictures and storing the same in a recording medium, the compression ratio of a stream of moving pictures should be sufficiently large not to overload the communication bandwidth and to prevent the recording capacity from becoming excessively large. Motion compensated interframe predictive coding is performed to improve the benefits of compressing moving pictures. In motion compensated interframe predictive coding, a frame to be coded is divided into blocks. Motion from a reference frame already coded is predicted block by block so as to detect a motion vector. Motion vector information as well as difference images are coded.

Japanese Patent Application Laid-open 2005-86834 describes a technology for decomposing motion pictures into temporal and spatial subbands through motion compensation analysis and spatial wavelet transform.

For precise prediction in H.264/AVC, a block size for use in motion compensation may be made variable or motion compensation accuracy of up to quarter-pixel may be supported, which will result in an increase in the amount of codes related to motion vectors. A study is underway to incorporate motion compensated temporal filtering (MCTF) in scalable video coding (SVC), a next-generation image compression technology, to improve temporal scalability. MCTF combines subband decomposition along the temporal axis with motion compensation. As such, it produces quite a large amount of information on motion vectors because of hierarchical motion compensation employed. Thus, technologies for compression coding of moving pictures recently adopted tend to produce an increase in the amount of data for a stream of moving pictures as a whole, as a result of an increase in the amount of information related to motion vectors. In this respect, there is a growing demand for a technology for reducing the amount of codes for motion vector information.

### SUMMARY OF THE INVENTION

A general purpose of the present invention is to provide a coding technology for moving pictures capable of reducing the amount of codes for motion vector information.

In a coding method according to one embodiment of the present invention for deriving a plurality of layers with different frame rates from moving pictures, coded data for the moving pictures includes information related to a difference between a motion vector obtained in a first layer and a predictive vector for predicting motion in the first layer by using a motion vector obtained in a second layer higher or lower than the first layer.

According to this embodiment, the amount of codes for motion vector information can be reduced so that compression efficiency of moving pictures is improved, by coding only a difference from a predictive vector.

The plurality of layers with different frame rates may be obtained by subjecting the moving pictures to motion compensation filtering. The above method is equally applicable to a coding method for obtaining a plurality of layers with different frame rates by subjecting the moving pictures to motion compensated temporal filtering according to the MCTF technology. With this, the amount of codes for motion vector information can be reduced in performing MCTF where motion vector information is obtained for each layer. Thus, the compression ratio of moving pictures is improved.

The predictive vector may predict a motion vector in the first layer according to a linear motion model which assumes that the rate of motion remains unchanged over a plurality of frames. With this, it is possible to reduce the amount of computation associated with generating the predictive vector can be reduced.

The second layer may be a layer of lower frame rate than the first layer and obtained by subjecting the first layer to temporal filtering. With this, the step of decoding coded data does not require a motion vector of a higher layer for generation of an image at a lower layer. Therefore, the advantage of temporal scalability does not suffer at the decoding end.

Information on the motion vector obtained in the first layer or the information related to the difference may be selectively included in coded data for moving pictures. With this, more suitable information can be included in the coded data for the moving pictures in accordance with the amount of computation in the coding apparatus or the amount of data resulting from coding.

It should be appreciated that any combinations of the foregoing components, and any conversions of expressions of the present invention from/into methods, apparatuses, systems, recording media, computer programs, and the like are also intended to constitute applicable aspects of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows the structure of a coding apparatus according to an embodiment of the present invention;

FIG. 2 shows how a low-pass frame is generated;

FIG. 3 shows how a high-pass frame is generated;

FIG. 4 shows the structure of an MCTF processor;

FIG. 5 shows images and motion vectors output in the layers;

FIG. 6 is a flowchart showing a coding method according to the MCTF technology;

FIG. 7 is a flowchart showing how a motion vector is coded according to the embodiment; and

FIG. 8 shows the structure of a decoder according to the embodiment.

### DETAILED DESCRIPTION OF THE INVENTION

The invention will now be described by reference to the preferred embodiments. This does not intend to limit the scope of the present invention, but to exemplify the invention.

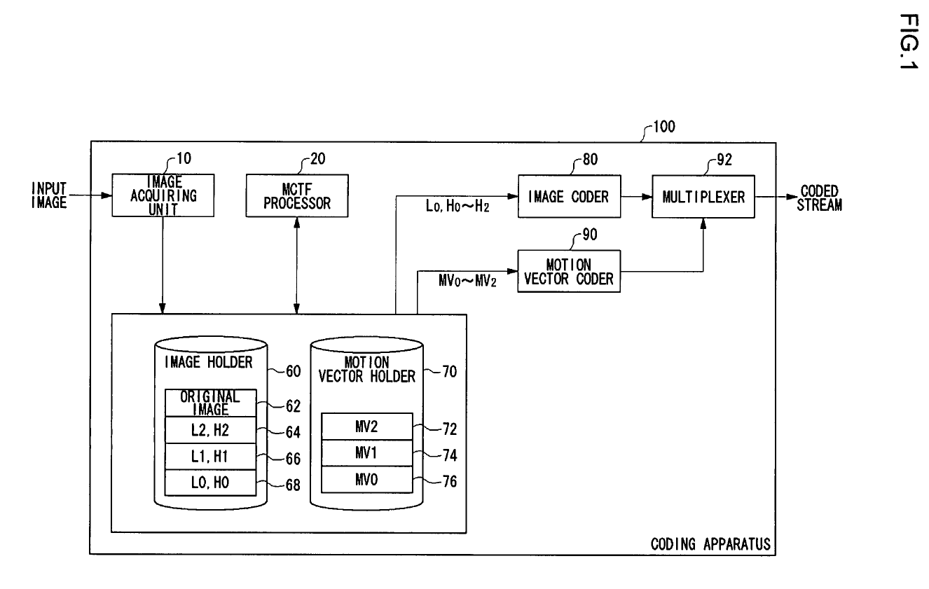

FIG. 1 shows the structure of a coding apparatus 100 according to an embodiment. The structure as illustrated may be implemented by hardware including a CPU, a memory and an LSI of an arbitrary computer and by software including a program provided with image coding functions loaded into the memory. FIG. 1 depicts functional blocks implemented by the cooperation of the hardware and software. Therefore, it will be obvious to those skilled in the art that the functional blocks may be implemented by a variety of manners including hardware only, software only or a combination of both.

The encoding apparatus 100 according to the present embodiment codes moving pictures in compliance with H.264/AVC, the latest standard for compression coding of moving pictures jointly standardized by International Organization for Standardization (ISO)/International Electrotechnical Commission (IEC) and International Telecommunication Union-Telecommunication Standardization Sector (ITU-T). The formal names of recommendations from the organizations are MPEG-4 Part 10: Advanced Video Coding and H. 264, respectively.

An image acquiring unit 10 of the coding apparatus 100 receives a group of pictures (GOP) and stores the frames in a dedicated area in an image holder 60. The image acquiring unit 10 may divide each frame into macroblocks as required.

An MCTF processor 20 performs motion compensated temporal filtering according to the MCTF technology. The MCTF processor 20 obtains motion vectors from the frames stored in the image holder 60 and uses the motion vectors to perform temporal filtering. Temporal filtering is performed by using Haar wavelet transform, with the result that the frames are decomposed into plural layers with different frame rates, each layer including high-pass frames H and low-pass frames L. The high-pass frames and the low-pass frames resulting from decomposition are stored in a dedicated area in the image holder 60 layer by layer. Motion vectors are also stored in a dedicated area in a motion vector holder 70. A detailed description of the MCTF processor 20 will be given later.

When the process in the MCTF processor 20 is completed, the high-pass frames at all layers and the low-pass frame at the lowest layer, which are stored in the image holder 60, are sent to an image coder 80. The motion vectors at all layers stored in the motion vector holder 70 are sent to a motion vector coder 90.

The image coder 80 subjects the frames supplied from the image holder 60 to spatial filtering using wavelet transform before coding the frames. The frames obtained by coding are sent to a multiplexer 92. The motion vector coder 90 codes the motion vectors supplied from the motion vector holder 70 and supplies the coded vectors to the multiplexer 92. The method of coding is known so that the detailed description thereof is omitted.

The multiplexer 92 multiplexes the coded frame information supplied from the image coder 80 and the coded motion vector information supplied from the vector coder 90 so as to generate a coded stream.

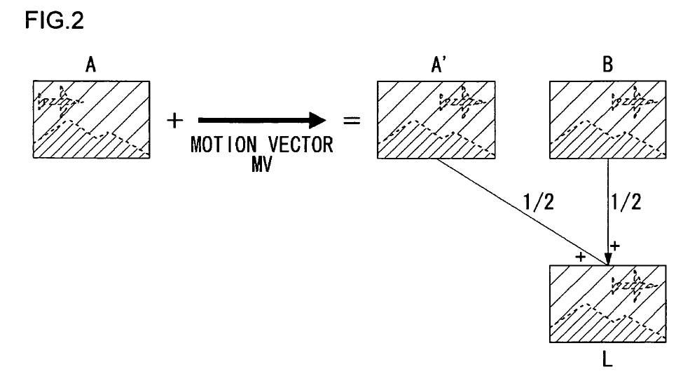

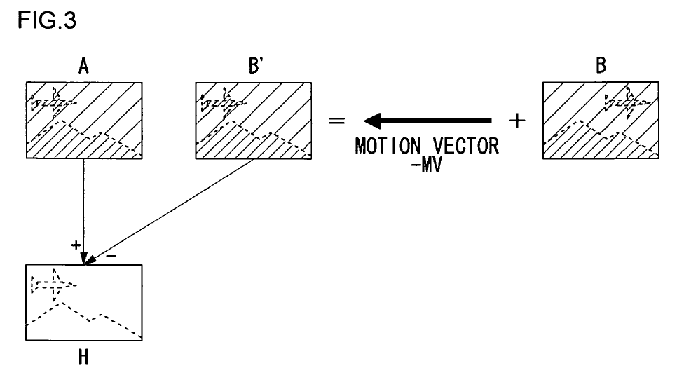

A description will now be given, with reference to FIGS. 2 and 3, of temporal filtering according to the MCTF technology.

The MCTF processor 20 acquires two successive frames within a GOP so as to generate a high-pass frame and a low-pass frame. The two frames will be referred to as “frame A” and “frame B” along the time axis.

The MCTF processor 20 detects a motion vector MV from the frame A and the frame B. FIGS. 2 and 3 show frame-by-frame motion vector detection for brevity. Alternatively, a motion vector may be detected for each macroblock or for each block (8×8 pixels or 4×4 pixels).

Subsequently, by compensating the frame A for motion with the motion vector MV, an image (hereinafter, referred to as “frame A′”) is generated.

The low-pass frame L is defined as an average of the frame A′ and the frame B, as shown in FIG. 2.
L=½*(A′+B) (1)

Subsequently, the frame B is compensated for motion by (−MV), an inverted version of the motion vector MV, so as to generate an image (hereinafter, referred to as “frame B′”).

The high-pass frame H is defined as a difference between the frame A and the frame B′, as shown in FIG. 3.
H=A−B′ (2)

Modifying the expression (2), we obtain;
A=B′+H (3)

Given that both the right-hand side and the left-hand side are compensated for motion by using the motion vector MV, the following expression holds.
A′=B+H′ (4)
where H′ denotes an image obtained by compensating the high-pass frame for motion by using the motion vector MV.

Substituting the expression (4) into the expression (2), we obtain;

$$\begin{matrix}L = \frac{1}{2} * ( {A}^{′} + B ) \\ = \frac{1}{2} * ( B + {H}^{′} + B ) \\ = B + \frac{1}{2} * {H}^{′}\end{matrix} \qquad ( 5 )$$

That is, the low-pass frame L can be generated by adding the pixel values of the frame B to the pixel values of the high-pass frame H′ each reduced to ½.

The high-pass frame H and the low-pass frame L thus generated will then be the new frame A and the new frame B, respectively. By repeating the same operation as described above on the new frames, high-pass frames, low-frequency frames and motion vectors at subsequent layers are generated. The operation is cyclically repeated until only one low-pass frame is generated. Thus, the number of layers obtained is determined by the number of frames included in a GOP. For example, if the GOP includes eight frames, the first operation generates four high-pass frames and four low-pass frames (layer 2), the second operation generates two high-pass frames and two low-pass frames (layer 1), and the third operation generates one high-pass frame and one low-pass frame (layer 0).

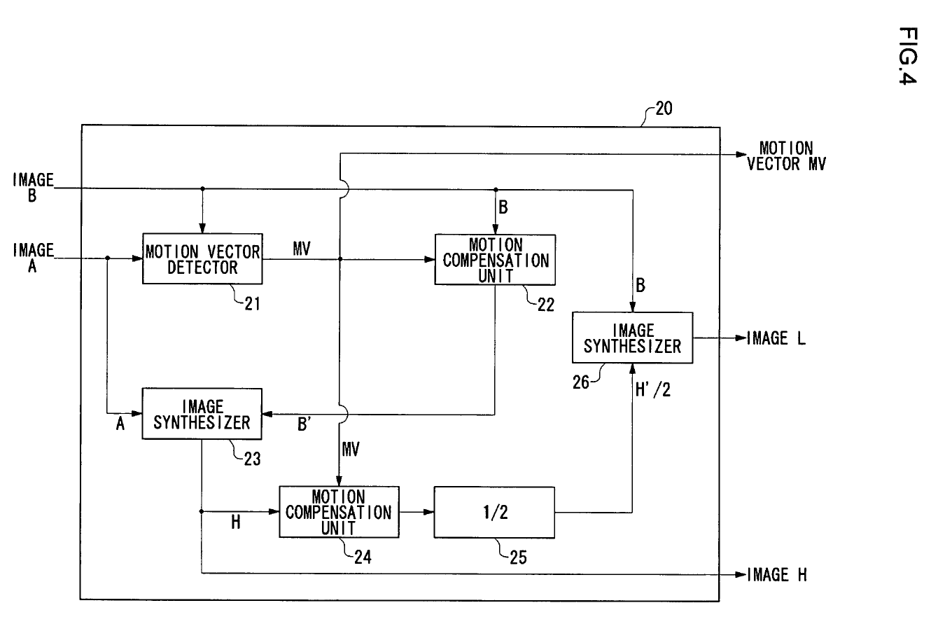

FIG. 4 shows the structure of the MCTF processor 20. The frame A and the frame B stored in the image holder 60 are input to a motion vector detector 21. It should be noted that, as described above, while the frame A and the frame B in layer 2 are frames that constitute the GOP, the frame A and the frame B in layer 1 and below are low-pass frames L generated in the layer.

The motion vector detector 21 searches the frame A for an area of prediction that gives the smallest error from each of the macroblocks in the frame B so as to obtain a motion vector MV indicating difference from the macroblock to the area of prediction. The motion vector MV is stored in the motion vector holder 70 and supplied to motion compensation units 22 and 24.

The motion compensation unit 22 uses an inverted version (−MV) of the motion vector MV output from the motion vector detector 21 to compensate the frame B for motion macroblock by macroblock, thereby generating the frame B′.

An image synthesizer 23 generates the high-pass frame H by adding the pixels of the frame A and those of the frame B′, which is output from the motion compensation unit 22. The high-pass frame H is stored in the image holder 60 and supplied to the motion compensation unit 24. The motion compensation unit 24 uses the motion vector MV to compensate the frame H for motion macroblock by macroblock, thereby generating the frame H′. The frame H′ thus obtained is multiplied by ½ by a processing block 25 before being supplied to the image synthesizer 26.

The image synthesizer 26 generates the low-pass frame L by adding the pixels of the frame B and those of the frame H′. The low-pass frame L thus generated is stored in the image holder 60.

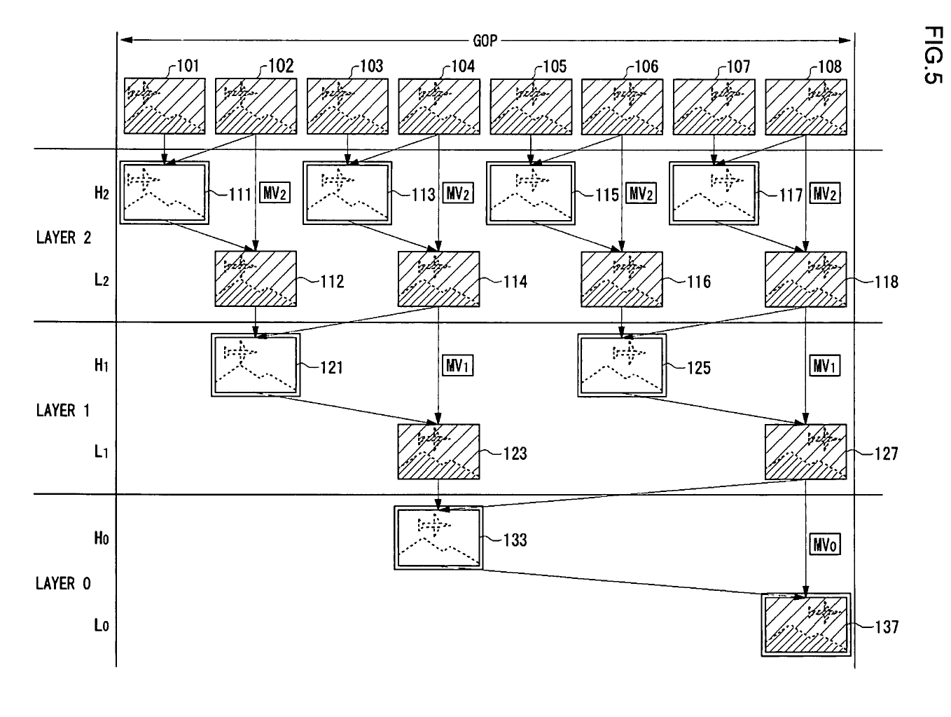

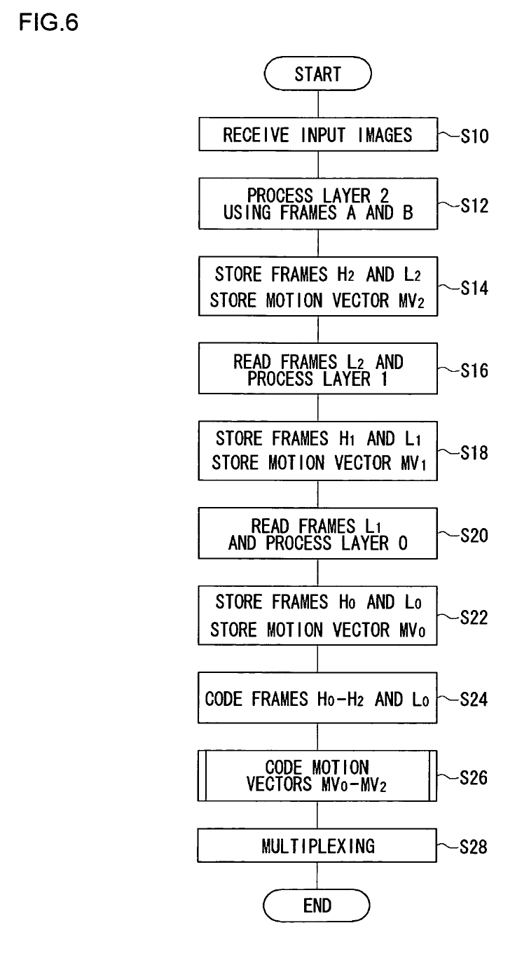

FIG. 5 shows images and motion vectors output in the layers, given a GOP comprising eight frames. FIG. 6 is a flowchart showing a coding method according to the MCTF technology. A specific example will be given by referring to FIGS. 5 and 6.

Hereinafter, the high-pass frame in layer n will be denoted by Hₙ, the low-pass frame in layer n will be denoted by Lₙ, and the motion vector in layer n by MVₙ. In the example of FIG. 5, frames 101, 103, 105, 107, of the frames 101-108 within the GOP, represent the frame A. Frames 102, 104, 106 and 108 represent the frame B.

Initially, the image acquiring unit 10 receives the frame A and the frame B so as to store them in the image holder 60 (S10). In this process, the image acquiring unit 10 may divide a frame into macroblocks. The MCTF processor 20 then reads the frame A and the frame B from the image holder 60 and performs the first temporal filtering process (S12). The high-pass frames H₂ and the low-pass frames L₂ generated as a result are stored in the image holder 60, and the motion vectors MV₂ are stored in the motion vector holder 70 (S14). When the frames 101-108 have been processed, the MCTF processor 20 reads the low-pass frames L2 from the image holder 60 and performs the second temporal filtering process (S16). The high-pass frames H₁ and the low-pass frames L₁ generated as a result are stored in the image holder 60, and the motion vectors MV₁ are stored in the motion vector holder 70 (S18). The MCTF processor then reads the two low-pass frames L1 from the image holder 60 and performs the third temporal filtering process (S20). The high-pass frame H₀ and the low-pass frame L0 generated as a result are stored in the image holder 60, and the motion vector MV₀ is stored in the motion vector holder 70 (S22).

The high-pass frames H₀-H₂ and the low-pass frame L0 are coded by the image coder 80 (S24), and the motion vectors MV₀-MV₂ are coded by the motion vector coder 90 (S26). The frames and the motion vectors thus coded are multiplexed by the multiplexer 92 and output as a coded stream (S28).

Since the high-pass frames H represent differences between frames, the amount of data to be coded is reduced accordingly. As shown in FIG. 5 the number of low-pass frames is reduced to ½ each time a temporal filtering process is performed. Because the low-pass frame L is an average of frames at the higher layer, a sequence of frames in which image quality and resolution are not degraded is obtained. Thus, moving pictures with different frame rates can be transmitted in a single bit stream.

The decoder which receives the coded bit stream performs a decoding process, proceeding from the bottom layer to the top layer. By decoding only lower layers, moving pictures at a low frame rate are obtained. As the decoding proceeds to higher layers, moving pictures at an increased frame rate are obtained. Thus, temporal filtering according to the MCTF technology achieves temporal scalability.

It will be note, however, that, temporal filtering according to the MCTF technology requires that motion vectors be coded at respective layers, with the result that the amount of codes for motion vector information will be relatively large. In this background, the present embodiment provides a technology for reducing the amount of codes for motion vector information.

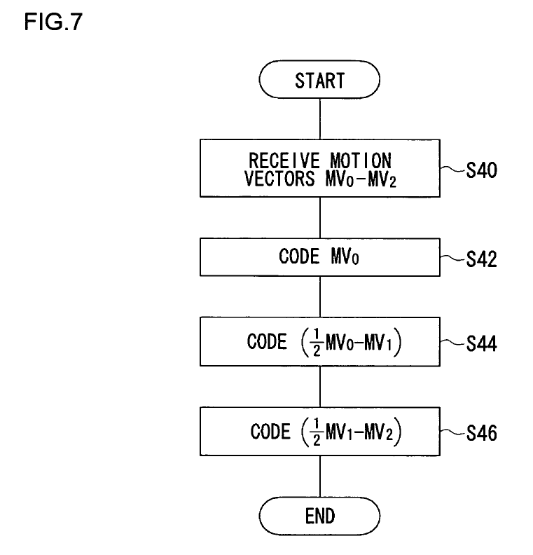

FIG. 7 is a flowchart showing how the motion vector coder 90 codes motion vectors. Motion vectors MV₀, MV₁ and MV₂ generated at layer 0-layer 2 shown in FIG. 5 will be given as examples.

The motion vector coder 90 performs coding on the motion vectors MV₀, MV₁ and MV₂ in the stated order. Initially, the motion vector coder 90 receives the motion vectors MV₀-MV₂ from the motion vector holder 70 (S40). The motion vector coder 90 codes the motion vector MV₀ at the lowest layer 0 (S42). Subsequently, the motion vector coder 90 codes (½*MV₀-MV₁) , which is a difference between ½ of MV₀ and MV₁, instead of coding the motion vector MV₁ at layer 1. Further, the motion vector coder 90 codes (½*MV₁-MV₂), which is a difference between ½ of MV₁ and MV₂, instead of coding the motion vector MV₂ at layer 2.

The idea behind this will be explained. Referring to FIG. 5, one low-pass frame (L0) 137 is generated based upon two low-pass frames (L1) 123 and 127 at layer 1. According to the linear motion model which assumes that the motion rate remains unchanged over plural frames, it is considered that the motion vector MV₁ at layer 1 has values half those of the motion vector MV₀ at layer 0. Therefore, the amount of codes for motion vector information can be reduced by coding a difference from a predictive vector obtained by reducing the motion vector MV₀ to ½, instead of coding MV₁ itself. Similarly, by coding a difference between the motion vector MV₂ and a predictive vector obtained by reducing the motion vector MV₁ to ½, the amount of codes for motion vector information can also be reduced.

In a similar approach, a difference (¼*MV₀-MV₂) between the motion vector MV₂ at layer 2 and a predictive vector obtained by reducing the motion vector MV₀ at layer 0 to ¼ may be coded. Alternatively, coding may be selectively performed on the information on the original vector itself or the information on the difference. For example, the difference may be coded if the amount of data for motion vector information resulting from coding exceeds a predetermined threshold. With this, more suitable information can be included in the coded data for the moving pictures in accordance with the amount of computation in the coding apparatus or the amount of data resulting from coding.

In hierarchical coding of moving pictures, the amount of codes for motion vectors will be relatively large so that motion vectors need be coded efficiently. According to the present embodiment, the size of motion vector information itself can be reduced so that the amount of codes can be reduced, by predicting motion vector information in MCTF from motion vector values in lower layers and coding differences from predictive vectors.

The predictive vector is determined in accordance with the number of frames at the higher layer and at the lower layer. For example, in case one low-pass frame is generated based upon three low-pass frames, the difference between a predictive vector obtained by reducing the motion vector at the lower layer to ⅓ and the motion vector at the higher layer is coded.

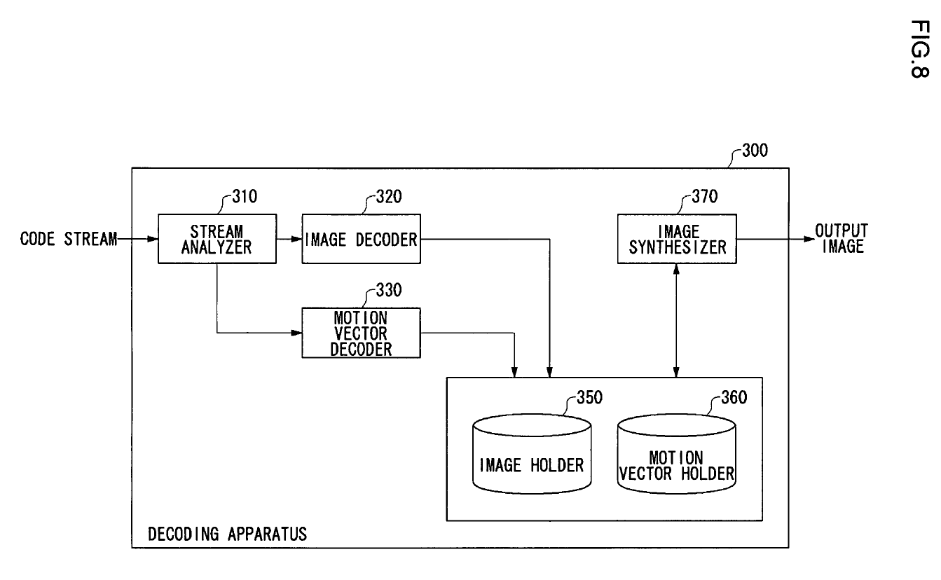

FIG. 8 shows the structure of a decoding apparatus 300 according to the embodiment. The coded stream is input to a stream analyzer 310 of the decoding apparatus 300. The stream analyzer 310 extracts a data portion corresponding to a desired layer and then isolates decoded data for frames from decoded data for motion vectors. The data for frames is supplied to an image decoder 320, and the data for motion vectors is supplied to a motion vector decoder 330.

The image decoder 320 performs entropy decoding and reverse wavelet transform so as to generate the low-pass frame L₀ at the lowest layer and the entirety of high-pass frames H₀-H₂. The frames produced by decoding in the image decoder 320 are stored in a dedicated area in an image holder 350.

The motion vector decoder 330 decodes the motion vector information and then calculates the motion vectors MV₁ and MV₂ at the higher layers from the motion vector MV₀ at the lowest layer and differences from therefrom. The motion vectors produced by decoding in the motion vector decoder 330 are stored in a dedicated area in a motion vector holder 360.

An image synthesizer 370 synthesizes frames in a reverse order from the MCTF process described above. The synthesized frames are output to an external destination and may be stored in the image holder 350 for further processing if frames at higher layers are necessary.

Each time the image synthesizer performs a synthesizing process, reproduction of moving pictures at a higher frame rate is achieved. Ultimately, moving pictures at the same frame rate as the input image are obtained.

As described, according to the coding apparatus 100 of the embodiment, the amount of data for motion vector information itself can be reduced by coding a difference between a motion vector at a higher layer and a predictive vector derived from a motion vector at a lower layer. Accordingly, the amount of codes for a stream of moving pictures as a whole can be reduced so that compression efficiency is improved. In decoding frames at a lower layer, the motion vector at a higher layer is not necessary so that the decoding apparatus need only decode up to a layer corresponding to a required frame rate. Therefore, the advantage of temporal scalability does not suffer.

The present embodiment is particularly suitable for coding of motion pictures using the MCTF technology because the number of motion vectors produced in the coding with the MCTF will be large.

The description of the invention given above is based upon the embodiment. The embodiment of the present invention is only illustrative in nature and it will be obvious to those skilled in the art that various variations in constituting elements and processes are possible and that such variations are also within the scope of the present invention.

The embodiment has been described above as being applied to motion vectors produced in an MCTF process using Haar wavelet transform in which one low-pass frame is generated from two successive frames. The embodiment may be applied equally to motion vectors produced in an MCTF process using 5/3 wavelet transform in which one high-pass frame is generated from three successive frames.

The coding apparatus 100 and the decoding apparatus 300 has been described above as coding and decoding moving pictures in compliance with H.264/AVC. The present invention may be applied equally to other methods for hierarchical coding and decoding of moving pictures having temporal scalability.

What is claimed is:

1. A coding method for deriving a plurality of layers with different frame rates from moving pictures, wherein coded data for the moving pictures includes information related to a difference between a motion vector obtained in a first layer and a predictive vector for predicting motion in the first layer by using a motion vector obtained in a second layer higher or lower than the first layer.

2. The coding method according to claim 1, wherein the predictive vector predicts a motion vector in the first layer according to a linear motion model which assumes that the rate of motion remains unchanged over a plurality of frames.

3. The coding method according to claim 2, wherein the second layer is a layer of lower frame rate than the first layer and is obtained by subjecting the first layer to temporal filtering.

4. The coding method according to claim 1, wherein information on the motion vector obtained in the first layer or the information related to the difference is selectively included in the coded data for the moving pictures.

5. A coding method for deriving a plurality of layers with different frame rates by subjecting moving pictures to motion-compensated temporal filtering, wherein coded data for the moving pictures includes information related to a difference between a motion vector obtained in a first layer and a predictive vector for predicting motion in the first layer by using a motion vector obtained in a second layer higher or lower than the first layer.

6. The coding method according to claim 5, wherein the predictive vector predicts a motion vector in the first layer according to a linear motion model which assumes that the rate of motion remains unchanged over a plurality of frames.

7. The coding method according to claim 6, wherein the second layer is a layer of lower frame rate than the first layer and is obtained by subjecting the first layer to temporal filtering.

8. The coding method according to claim 5, wherein information on the motion vector obtained in the first layer or the information related to the difference is selectively included in the coded data for the moving pictures.
